(19) United States
(12) Patent Application Publication
(10) Pub. No.: US 2026/0181389 A1
(43) Pub. Date: Jun. 25, 2026

(54) AUTHENTICATION AND ENCRYPTION METHOD AND DEVICE FOR USER PLANE FUNCTION SERVICE IN WIRELESS COMMUNICATION SYSTEM

(71) Applicant: Samsung Electronics Co., Ltd., Gyeonggi-do (KR)

(72) Inventors: Kisuk KWEON, Gyeonggi-do (KR); Sangsoo JEONG, Gyeonggi-do (KR)

(21) Appl. No.: 19/128,744

(22) PCT Filed: Nov. 13, 2023
(86) PCT No.: PCT/KR2023/018178

§ 371 Date: May 9, 2025

(30) Foreign Application Priority Data
Nov. 15, 2022 (KR) 10-2022-0152831

(51) Int. Cl. H04W 12/06; H04W 12/037; H04W 12/0431; H04W 60/04

(52) U.S. Cl. CPC H04W 12/06; H04W 12/037; H04W 12/0431; H04W 60/04

(57) ABSTRACT

The present invention relates to a 5G or 6G communication system for supporting higher data transmission rates. A method performed by a user plane function (UPF) entity in a communication system according to the present invention comprises the steps of: receiving a subscription request message including first authentication information from an external network function (NF) entity; and transmitting a subscription response message including second authentication information to the external NF entity, wherein the first authentication information, the second authentication information, and third authentication information acquired by the external NF entity may be used for mutual authentication between a network including the external NF entity and a network including the UPF entity.

### TECHNICAL FIELD

The disclosure relates to a wireless communication system, and proposes an authentication method for an NF requesting a service provided by a UPF and an encryption method for securely transmitting a control message for a UPF service.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, Al-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DETAILED DESCRIPTION OF THE INVENTION

### Technical Problem

The disclosure provides a method and device for securely and effectively providing a user plane function (UPF) service in a wireless communication system.

### Technical Solution

According to an embodiment of the disclosure, there are provided a method for mutual authentication between an NF requesting a service and a communication network when a network device or function requests a user plane function (UPF) service based on a user plane (UP) to use a service provided by a UPF and a method for encrypting messages to securely transmit/receive control messages for the UPF service.

According to an embodiment of the disclosure, a method performed by a user plane function (UPF) entity in a wireless communication system may comprise receiving a registration request message including first authentication information from an external network function (NF) entity, and transmitting a registration response message including second authentication information to the external NF entity. The first authentication information, the second authentication information, and third authentication information obtained by the external NF entity may be used for mutual authentication between a network including the UPF entity and the external NF entity.

According to an embodiment of the disclosure, a method performed by an external network function (NF) entity in a wireless communication system may comprise obtaining first authentication information and second authentication information based on a preconfigured key for the external NF entity, transmitting a registration request message including the first authentication information to a user plane function (UPF) entity, receiving a registration response message including third authentication information from the UPF, and determining whether the second authentication information and the third authentication information are the same. The first authentication information, the second authentication information, and the third authentication information may be used for mutual authentication between a network including the UPF entity and the external NF entity.

According to an embodiment of the disclosure, a user plane function (UPF) entity in a wireless communication system may comprise a transceiver and at least one processor, The at least one processor may be configured to receive a registration request message including first authentication information from an external network function (NF) entity and transmit a registration response message including second authentication information to the external NF entity. The first authentication information, the second authentication information, and third authentication information obtained by the external NF entity may be used for mutual authentication between a network including the UPF entity and the external NF entity.

According to an embodiment of the disclosure, an external network function (NF) entity in a wireless communication system may comprise a transceiver and at least one processor. The at least one processor may be configured to obtain first authentication information and second authentication information based on a preconfigured key for the external NF entity, transmit a registration request message including the first authentication information to a user plane function (UPF) entity, receive a registration response message including third authentication information from the UPF, and determine whether the second authentication information and the third authentication information are the same. The first authentication information, the second authentication information, and the third authentication information may be used for mutual authentication between a network including the UPF entity and the external NF entity.

According to an embodiment of the disclosure, a method performed by a user plane function (UPF) entity in a wireless communication system may comprise receiving a registration request message including first authentication information from an external network function (NF) entity, and transmitting a registration response message including second authentication information to the external NF entity. The first authentication information and the second authentication information may be used for mutual authentication between a network including the UPF entity and the external NF entity,

According to an embodiment of the disclosure, a method performed by an external network function (NF) entity in a wireless communication system may comprise obtaining first authentication information and second authentication information based on a preconfigured key for the external NF entity, transmitting a registration request message including the first authentication information to a user plane function (UPF) entity, receiving a registration response message including third authentication information from the UPF, and determining whether the second authentication information and the third authentication information are the same. The first authentication information, the second authentication information, and the third authentication information may be used for mutual authentication between a network including the UPF entity and the external NF entity.

### Advantageous Effects

According to various embodiments of the disclosure, there is provided a device and method for transmitting a control message directly through a UPF in a wireless communication system.

According to various embodiments of the disclosure, there is provided a method for encryption and decryption for a message (e.g., UPF control message protocol (UCMP)) transmitted between a UPF and an AF in a wireless communication system.

### BRIEF DESCRIPTION OF DRAWINGS

FIG. 1 illustrates a structure of a 5G network according to an embodiment of the disclosure.

FIG. 2 illustrates an IP layer structure according to an embodiment of the disclosure.

FIG. 3 illustrates a UCMP protocol message format according to an embodiment of the disclosure.

FIG. 4 illustrates a communication method using a UCMP protocol according to an embodiment of the disclosure.

FIG. 5 illustrates a mutual authentication procedure between a network and an external server according to an embodiment of the disclosure.

FIG. 6 illustrates a UCMP message encryption procedure according to an embodiment of the disclosure,

The UPF of FIG. 7 may be understood as corresponding to the UPF of FIGS. I to 6 described above.

FIG. 8 is a view illustrating a configuration of a consumer NF according to an embodiment of the disclosure.

FIG. 9 is a view illustrating a configuration of a network entity according to an embodiment of the disclosure.

### MODE FOR CARRYING OUT THE INVENTION

Hereinafter, embodiments of the present invention are described in detail with reference to the accompanying drawings. The same reference denotations may be used to refer to the same or similar elements throughout the specification and the drawings. When making the gist of the present invention, the detailed description of known functions or configurations is skipped.

In describing the embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the disclosure, and methods for achieving the same may be understood through the embodiments to be described below taken in conjunction with the accompanying drawings. However, the present disclosure is not limited to the embodiments disclosed herein, and various changes may be made thereto. The embodiments disclosed herein are provided only to inform one of ordinary skilled in the art of the category of the present disclosure, The present disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card.

Hereinafter, the base station may be an entity allocating a resource to the UE and may be at least one of a NodeB, Node B, base station (BS), eNode B (eNB), gNode B (gNB), radio access unit, base station controller, or node on network. The UE may include UE (user equipment), MS (mobile station), cellular phone, smartphone, computer, or multimedia system capable of performing communication functions. The embodiments of the present invention may also apply to other communication systems with similar technical background or channel form. Further, embodiments of the present invention may be modified in such a range as not to significantly depart from the scope of the present invention under the determination by one of ordinary skill in the art and such modifications may be applicable to other communication systems.

As used herein, terms for identifying access nodes, terms denoting network entities or network functions (NFs), terms denoting messages, terms denoting inter-network entity interfaces, and terms denoting various pieces of identification information are provided as an example for ease of description. Thus, the disclosure is not limited by the terms, and such terms may be replaced with other terms denoting objects with equivalent technical concept.

For ease of description, hereinafter, some of the terms and names defined in the 3rd generation partnership project long term evolution (3GPP LTE) standards may be used. However, the disclosure is not limited by such terms and names and may be likewise applicable to systems conforming to other standards.

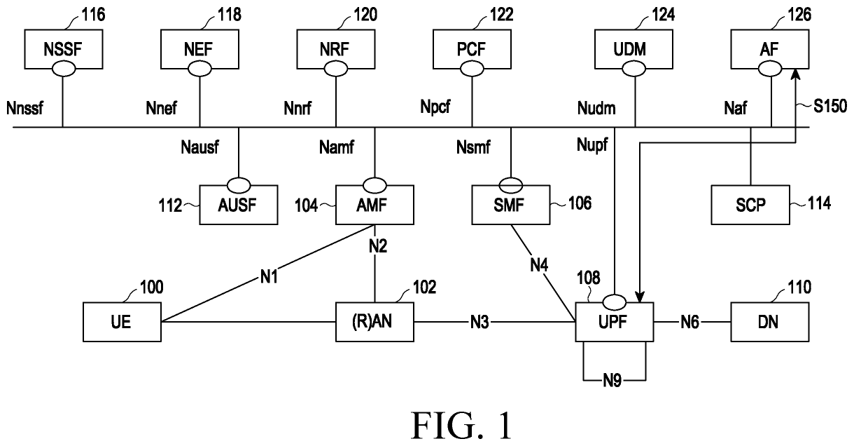

FIG. 1 is a view illustrating a structure of a 5G network according to an embodiment of the disclosure; The network entities or network nodes constituting a 5G network are described below.

The (radio) access network ((R)AN) 102 is an entity that allocates a radio resource to the UE 100 may be at least one of an eNode B, Node B, base station (BS), next generation radio access network (NG-RAN), 5G-AN, radio access unit, base station controller, or a node on network. The UE 100 may include UE (user equipment), next generation (NG) UE, mobile station (MS), cellular phone, smartphone, computer, or multimedia system capable of performing communication functions. Although embodiments of the disclosure are described below in connection with a 5G system, the embodiments of the disclosure may also be applicable to other communication systems with a similar technical background. Further, embodiments of the present invention may be modified in such a range as not to significantly depart from the scope of the present invention under the determination by one of ordinary skill in the art and such modifications may be applicable to other communication systems.

As evolving from a 4G to 5G system, the wireless communication system defines a new core network, e.g., NextGen core (NG Core) or 5G core network (5GC). In the new core network, the legacy network entities (NEs) all are virtualized into network functions (NFs). According to an embodiment, network function may mean a network entity, network component, or network resource.

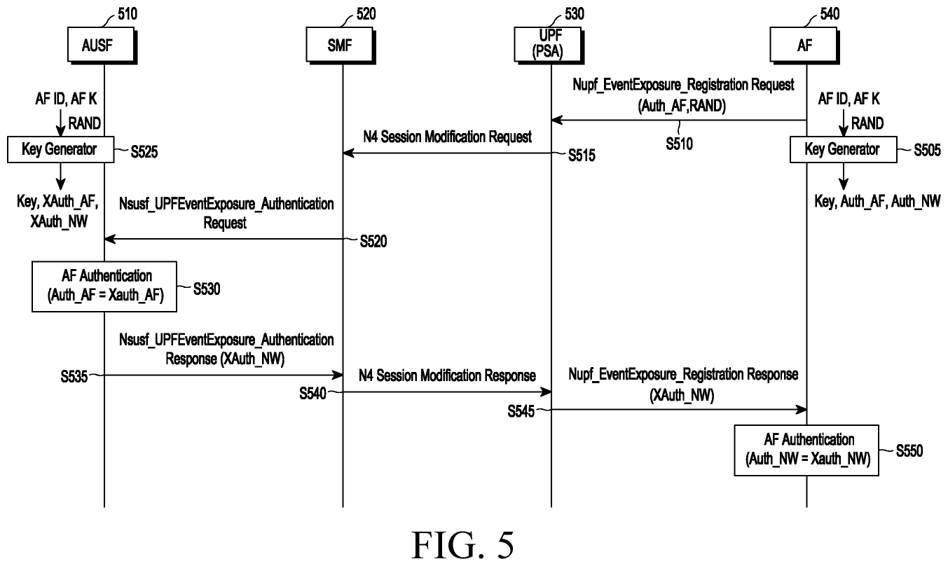

According to an embodiment, SGC may include NFs as illustrated in FIG. 1. Without limitations to the example of FIGS. 1, 5GC may include more or less NFs than those shown in FIG. 1.

According to an embodiment, the access and mobility management function (AMF) 104 may be a network function that manages the mobility of the UE.

According to an embodiment, a session management function (SMF) 106 may be a network function that manages a packet data network (PDN) connection provided to the UE. The PDN connection may be referred to as a packet data unit (PDU) session.

According to an embodiment, the policy control function (PCF) 122 may be a network function that applies a service policy, billing policy, and PDU session policy of the mobile communication service provider to the UE.

According to an embodiment, the unified data management (UDM) 124 may be a network function that stores information about the subscriber.

According to an embodiment, the network exposure function (NEF) 118 may be a function of providing information about the UE to a server outside the 5G network. The NEF 118 may also provide a function of providing information necessary for a service to the 5G network and storing it in the UDR.

According to an embodiment, the user plane function (UPF) 108 may serve as a gateway and router for transmitting user data (PDU) to a data network (DN) 110.

According to an embodiment, the network repository function (NRF) 120 may perform a function of discovering an NF.

According to an embodiment, the authentication server function (AUSF) 112 may perform authentication on the UE in a 3GPP access network and a non-3GPP access network.

According to an embodiment of the disclosure, the network slice selection function (NSSF) may perform a function of selecting a network slice instance provided to the UE.

According to an embodiment, the data network (DN) 110 may be a data network through which the UE transmits and receives data to use a service of the network operator or a 3rd party service.

The NFs of the disclosure may be configured as different devices as individual entities or may be configured to be all included in one core network.

According to an embodiment proposed in the disclosure, the AF 126 and the UPF 108 may perform connection through Nupf and may transmit/receive control messages or data directly without relying on other network entities (step S150).

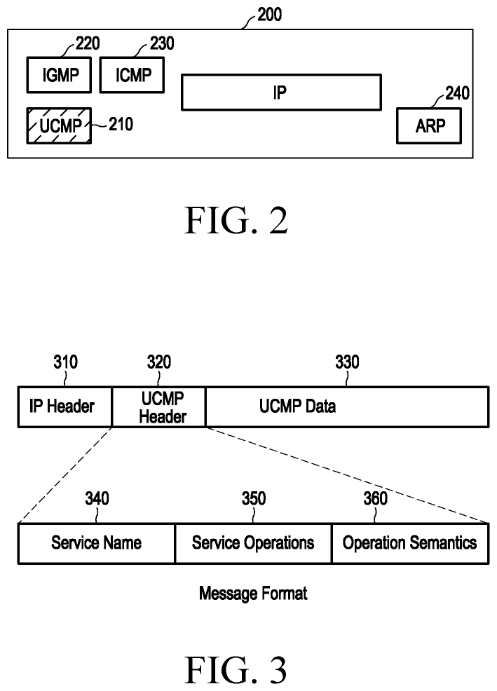

FIG. 2 illustrates an IP layer structure according to an embodiment of the disclosure, FIG. 3 illustrates a UPF control message protocol (UCMP) protocol message format according to an embodiment of the disclosure.

FIGS. 2 and 3 may represent an IP datagram including a UCMP protocol message (IPv4-based.IPv6 may also be applied in the same manner).

Referring to FIG. 2, the UCMP protocol 210 is a newly proposed protocol that enables network functions (NFs) to use services provided from the UPF through the user plane (UP) and may be included in the IP layer, like the Internet group management protocol (IGMP) 220, Internet control message protocol (ICMP) 230, or address resolution protocol (ARP) 240. When the UCMP protocol is included, the external NF may transmit a control message or a message including data through the UPF of the core network.

A specific value (e.g., ‘144’) may be input as the value of the protocol field of the IP header including the UCMP protocol message.

Referring to FIG. 3, the UCMP protocol message format may include an IP header field 310, a UCMP header field 320, and a UCMP data field. The IP header field 310 may include the header of the IP datagram. In an embodiment, a specific value (e.g., ‘144’) may be input to the IP header field to indicate that the corresponding IP datagram includes a UCMP message. The UCMP header field 320 may include a service name field 340, a service operation field 350, and an operation semantics field 360. The UCMP data field 330 may include parameter values required for UPF services.

According to an embodiment, the ‘Nupf EventExposure’ value which is an UPF service name may be input to the service name field 340. The ‘Subscription’ value which is a service subscription may be input to the service operations field 350. The ‘Request’ value for a service request may be input to the operation semantics field 360, and the ‘Response’ value which is a response to the service request may be input.

According to an embodiment, the UCMP data field 330 may include various parameters such as event ID, UE IP address, general public subscription identifier (GPSI), data network name (DNN), and single network slice selection assistance information (S-NSSAI).

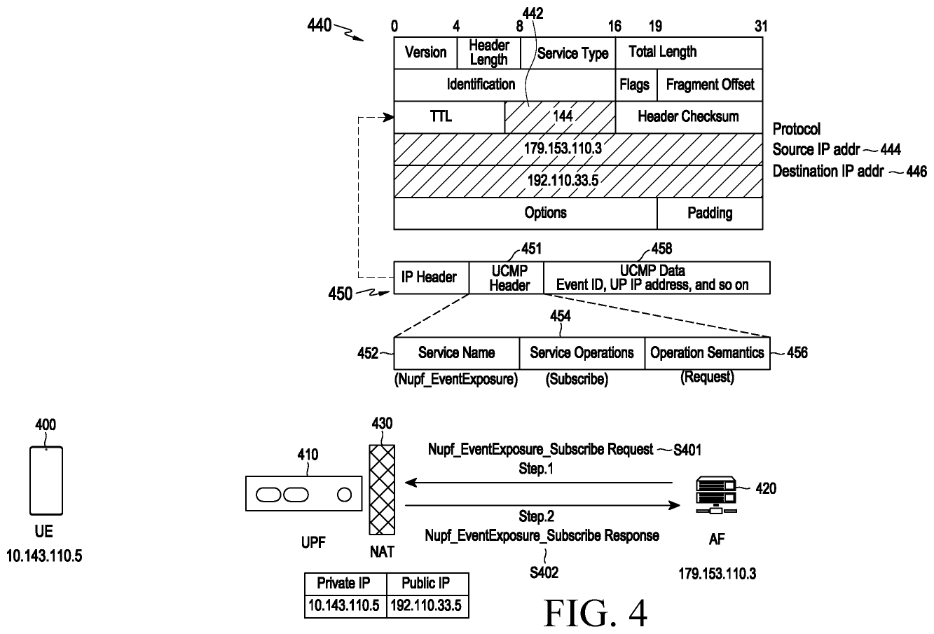

FIG. 4 illustrates a communication method using a UCMP protocol according to an embodiment of the disclosure.

Referring to FIG. 4, an embodiment of performing communication using a UCMP protocol is illustrated. In FIG. 4, the UE 400 is allocated a private IP address of 10.143.110.5 from the UPF 410 in one PDU session. The UE 400 may receive a specific service from the application function (AF) 420 which is an external server through the PDU session. The AF 420 may provide a specific service to the UE 400 by using 420.153.110.3 which is the public IP address of the AF. The communication service provider may change the private IP address allocated to the UE 400 into a public IP address that may be used in the public network using the network address translation (NAT) device 430 and transmit it to the external network. Referring to FIG. 4, the private IP address of the UE, 10.143.110.5, may be changed to the public IP address 192.110.33.5. In other words, the AF 420 outside the communication service provider network may identify the IP address of the UE as 192.110.33.5 which is the IP address changed by the NAT. The AF 420 which is an external server may request to subscribe to a UPF service in order to use a specific service of the UPF 410 (step S401). To this end, a UCMP protocol message 450 may be generated and included in the IP datagram 440 and sent. A specific value (e.g., ‘144’) may be input to the protocol field 442 of the IP header to indicate that the IP datagram 440 includes the UCMP message 450. An IP address value (e.g., ‘179.153.110.3’) of the AF 420 may be input to the source IP address field 444. A public IP address value (e.g., ‘192.110.33.5’) of the UE 400 may be input to the destination address field 446.

The UCMP header field 451 of the UCMP protocol message 450 may include a service name field 452, a service operation field 454, and an operation semantics field 456, In step S401, the ‘Nupf_EventExposure’ value which is an UPF service name may be input to the service name field 452, The ‘Subscribe’ value which indicates a service subscription as the service operation may be input to the service operations field 454. The ‘Request’ value which indicates a service request may be input to the operation semantics field 456. The UCMP data field 458 may include parameter values required for requesting to subscribe to the corresponding service. The parameter values may include various values such as event ID, UE IP address. general public subscription identifier (GPSI), data network name (DNN), and single network slice selection assistance information (S-NSSAI).

Referring to FIG. 4, the IP datagram 440 may be transmitted to a PDU session anchor (PSA) UPF, which is the home router of the UE. The UPF 410 may process the header of the IP datagram. In this case, since the value of the IP protocol field is ‘144’, the UPF 410 may recognize that the IP datagram includes the UCMP message. In other words, the IP datagram 440 does not include user data transmitted to the user UE 400, but includes a UCMP message requesting a service from the UPF 410 serving the UE 400. The UPF 410 may read the UCMP message and process the requested service subscription. The UPF 410 may discard the IP datagram 440 without transmitting the same to the UE 400. The UPF 410 may transmit a result of processing the requested service subscription to the AF 420. To this end, a UCMP message may be generated (step S402). In step S402, the following values may be input to the UCMP header field 451. The ‘Nupf EventExposure’ value which is an UPF service name may be input to the service name field 452. The ‘Subscribe’ value which indicates a service subscription as the service operation may be input to the service operations field 454. The ‘Response’ value which indicates a response to the service request may be input to the operation semantics field 456. The UCMP data field 458 may include parameter values required for responding to the service subscription request. The parameter values may include various values such as event ID, UE IP address, general public subscription identifier (GPSI), data network name (DNN), and single network slice selection assistance information (S-NSSAI).

FIG. 5 illustrates a mutual authentication procedure between a network and an external server according to an embodiment of the disclosure.

To use the service of the UPF 530, the external NF (the AF 540 of FIG. 5) should be allocated a credential (e.g., AF K) offline. In the disclosure, the description has been made based on the evolved packet system based authentication and key agreement (EPS-AKA) method, but the proposed methods may be extended to, and include, other security protocols (e.g., EAP-AKA, extensible authentication protocol AKA) method.

In step S510, a consumer NF (assumed to be the AF 540 in the disclosure) may perform a registration procedure in a communication network to use an UPF service, In order to perform a registration procedure, the network and the AF 540 may perform mutual authentication. Before step S510, in step S505, the AF 540 may obtain an authentication key Key, application authentication information Auth_AF, and network authentication information Auth_NW as output values by inputting AF key information (e.g., AF K), identifier information (AF ID) about the AF, and a random value RAND to the key generator. The AF key information AF K, the identifier information AF ID about the AF, and the random value RAND are information preset between operators and may be information shared with the network. Alternatively, it may be information previously transmitted and received between the network and the AF 540 through communication and stored. Here, the key generator may be preconfigured to use a single function, or a method of specifying by transmitting an indicator representing a specific function for a plurality of pre-stored functions may be used.

In step S510, the AF 540 may include the application authentication information (Auth_AF value), the random value (RAND value), and the identifier information (AF ID) about the AF obtained in step S505 as parameters in the registration request message and transmit them to the UPF 530.

In steps S515 and S520, the UPF 530 may transmit information included in the registration request message received from the AF 540 for AF authentication to the AUSF 510 through the serving SMF 520.

In step S525, the AUSF 510 may obtain an authentication key Key, application authentication information XAuth_AF, and network authentication information XAuth_NW as output values by inputting the AF ID and RAND value received in step S520 and the AF key information AF K allocated to the AF offline to the same key generator as the key generator used in the AF.

In step S530, the AUSF 510 may compare the received Auth_AF value with the XAuth_AF obtained as the output value of the key generator in step S525. When Auth_AF and XAuth_AF represent the same value, it may be determined that authentication for AF has been successful.

If the authentication for the AF 540 is successful in step S530, the AUSF 510 may include the network authentication information XAuth_NW value obtained in step S525 in the registration response message through the SMF 520 and the UPF 530 and transmit it to the AF 540 through steps S535 to S545.

In step S550, the AF 540 may authenticate the network by comparing the network authentication information XAuth_NW value received through the registration response message with the Auth_NW value obtained as the output value of the key generator in step S505. When Auth_AF and XAuth_AF represent the same value, it may be determined that authentication for AF has been successful.

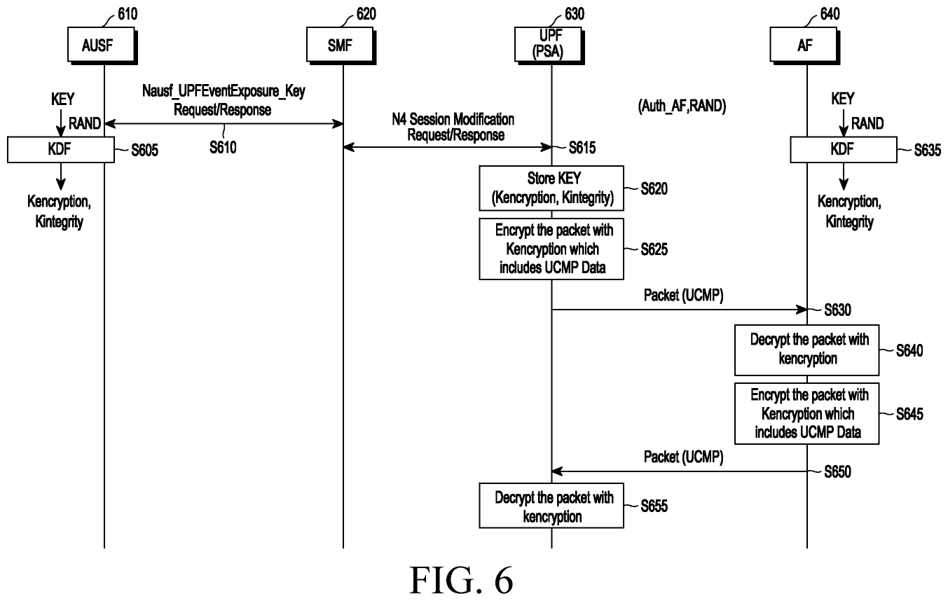

FIG. 6 illustrates a UCMP message encryption procedure according to an embodiment of the disclosure.

In FIG. 6, the description has been made based on the evolved packet system based authentication and key agreement (EPS-AKA) method, but the proposed methods may be extended to, and include, other security protocols (e.g., EAP-AKA, extensible authentication protocol AKA) method. FIG. 6 may illustrate operations performed after the procedure of FIG. 5 described above is performed.

In steps S605 and S635, the AUSF 610 and the NF (e.g., the AF of FIG. 5) 640 may input the authentication key (KEY value) and the random value RAND, as input values, generated in FIG. 5 into a key derivative function (KDF) to generate Kencryption which is a key for message encryption and Kintegrity which is a key for a message integrity check.

In steps S610 and S615, the AUSF 610 may transmit at least one of the two keys generated in step S605 to the UPF 630 via the SMF 620.

In step S620, the UPF 630 may store the two keys received from the AUSF 610 through the SMF 620 in step S615.

In step S625, when there is a UCMP message to be transmitted to the NF 640, the UPF 630 may encrypt the corresponding UCMP message using stored Kencryption. If an integrity check is also required for the corresponding UCMP message, the stored Kintegrity may be used. The UCMP message may be a control message.

In step S630, the UPF 630 may transmit the UCMP message encrypted with Kencryption to the NF 640.

In step S640, the NF 640 may restore and process the encrypted UCMP message received by using Kencryption obtained in step S635. If an integrity check is also required, an integrity check may be performed using Kintegrity obtained in step S635.

Separately from steps S630 and S640, when there is a UCMP message to be transmitted to the UPF 630 in step S645, the NF 640 may encrypt the corresponding UCMP message with Kencryption obtained in step S635. If an integrity check is also required, an integrity check may be performed using Kintegrity obtained in step S635. The corresponding UCMP message may be a control message.

In step S650, the NF 640 may transmit the UCMP message encrypted with Kencryption to the UPF 630.

When receiving the UCMP message from the NF 640 in S655, the UPF 630 may restore and process the received UCMP message using the encryption key, Kencryption, which is received and stored in step S615. If an integrity check is also required, an integrity check may be performed using Kintegrity received and stored in step S615.

According to an embodiment of the disclosure, a method performed by a user plane function (UPF) entity in a wireless communication system may comprise receiving a registration request message including first authentication information (e.g., the Auth_AF of FIG. 5) from an external network function (NF) entity, and transmitting a registration response message including second authentication information (e.g., the XAuth_NW of FIG. 5) to the external NF entity. The first authentication information and the second authentication information may be used for mutual authentication between a network including the UPF entity and the external NF entity.

The method may further comprise receiving a message including an encryption key and an integrity key from an authentication server function (AUSF) entity, storing the encryption key and the integrity key, encrypting a first UPF control message protocol (UCMP) message based on the encryption key, and transmitting the encrypted first UCMP message to the external NF entity.

The method may further comprise receiving another encrypted UCMP message from the external NF entity, and decrypting the other UCMP message based on the encryption key.

According to an embodiment of the disclosure, a method performed by an external network function (NF) entity in a wireless communication system may comprise obtaining first authentication information (e.g., the Auth_AF of FIG. 5) and second authentication information (e.g., the Auth_NW of FIG. 5) based on a preconfigured key for the external NF entity, transmitting a registration request message including the first authentication information to a user plane function (UPF) entity, receiving a registration response message including third authentication information (e.g., the XAuth_NW of FIG. 5) from the UPF, and determining whether the second authentication information and the third authentication information are the same. The first authentication information, the second authentication information, and the third authentication information may be used for mutual authentication between a network including the UPF entity and the external NF entity.

The method may further comprise obtaining an authentication key based on a key for the external NF entity, obtaining an encryption key and an integrity key based on the authentication key, receiving a first UPF control message protocol (UCMP) message from the UPF entity, and decrypting the received UCMP message based on the encryption key.

The method may further comprise encrypting another UCMP message based on the encryption key and transmitting the encrypted other UCMP message to the UPF entity.

FIG. 7 is a view illustrating a configuration of a UPF according to an embodiment of the disclosure.

The UPF of FIG. 7 may be understood as corresponding to the UPF of FIGS. 1 to 6 described above.

A UPF (or UPF entity) according to an embodiment of the disclosure may include a controller (or processor) 710 controlling the overall operation of the UPF, a transceiver (or transmission/reception unit) 720 including a transmitter and a receiver, and memory (not illustrated). Without limited thereto, the UPF may include more or less components than those shown in FIG. 7.

According to an embodiment of the disclosure, the transceiver 720 may transmit/receive signals to/from other network entities 900, a consumer NF 800 or a UE (not illustrated). The signals transmitted/received with the network entity may include control information and data. The transceiver 720 may receive signals via a radio channel, output the signals to the processor 710, and transmit signals output from the processor 710 via a radio channel.

According to an embodiment of the disclosure, the processor 710 may control the UPF to perform any one of the above-described embodiments. The processor 710, the memory (not illustrated), and the transceiver 720 are not necessarily implemented in separate modules but rather as a single component, e.g., a single chip. The processor 710 and the transceiver 720 may be electrically connected with each other. The processor 710 may be an application processor (AP), a communication processor (CP), a circuit, an application-specific circuit, or at least one processor.

According to an embodiment of the disclosure, the memory (not illustrated) may store a default program for operating the UE, application programs, and data, such as configuration information. The memory provides the stored data according to a request of the processor 710. The memory may include a storage medium, such as ROM, RAM, hard disk, CD-ROM, and DVD, or a combination of storage media. There may be provided a plurality of memories. The processor 710 may perform the above-described embodiments based on a program for performing the above-described embodiments stored in the memory.

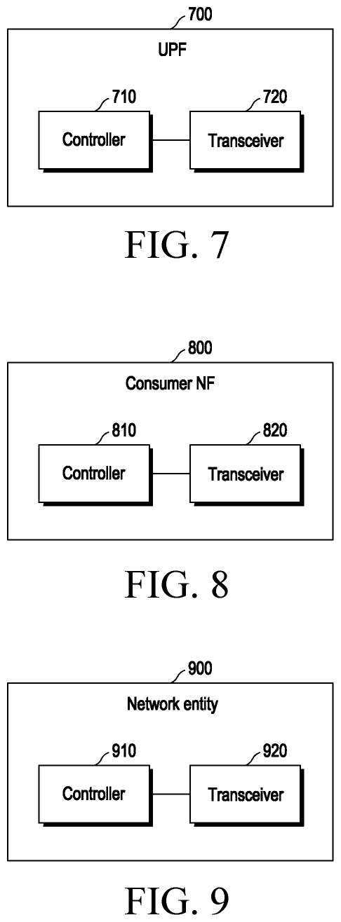

FIG. 8 is a view illustrating a configuration of a consumer NF according to an embodiment of the disclosure.

According to an embodiment of the disclosure, the consumer NF 800 may include the AF 126 of FIG. 1, the AF 420 of FIG. 4, the AF540 of FIG. 5, or the NF 640 of FIG. 6.

The consumer NF 800 according to an embodiment of the disclosure may include a controller (or processor) 810 controlling the overall operation of the consumer NF, a transceiver (or transmission/reception unit) 820 including a transmitter and a receiver, and memory (not illustrated). Without limited thereto, the consumer NF may include more or less components than those shown in FIG. 8.

According to an embodiment of the disclosure, the transceiver 820 may transmit/receive signals to/from other network entities 900, a UPF 700 or a UE (not illustrated). The signals transmitted/received with the network entity may include control information and data. The transceiver 820 may receive signals via a radio channel, output the signals to the processor 810, and transmit signals output from the processor 810 via a radio channel.

According to an embodiment of the disclosure, the processor 810 may control the consumer NF to perform any one of the above-described embodiments. The processor 810, the memory (not illustrated), and the transceiver 820 are not necessarily implemented in separate modules but rather as a single component, e.g., a single chip. The processor 810 and the transceiver 820 may be electrically connected with each other. The processor 810 may be an application processor (AP), a communication processor (CP), a circuit, an application-specific circuit, or at least one processor.

According to an embodiment of the disclosure, the memory (not illustrated) may store a default program for operating the UE, application programs, and data, such as configuration information. The memory provides the stored data according to a request of the processor 810. The memory may include a storage medium, such as ROM, RAM, hard disk, CD-ROM, and DVD, or a combination of storage media. There may be provided a plurality of memories. The processor 810 may perform the above-described embodiments based on a program for performing the above-described embodiments stored in the memory.

FIG. 9 is a view illustrating a configuration of a network entity according to an embodiment of the disclosure.

According to an embodiment of the disclosure, the network entity 900 may include the RAN 102, the AMF 104, the SMF 106, the AUSF 112, the DN 110, the PCF 122, the SCP 114, the NEF 118, the NRF 120, or the UDM 124 of FIG. 1, the AUSF 510 or the SMF 520 of FIG. 5, or the AUSF 610 or the SMF 620 of FIG. 6.

The network entity 900 according to an embodiment of the disclosure may include a controller (or processor) 910 controlling the overall operation of the network entity, a transceiver (or transmission/reception unit) 920 including a transmitter and a receiver, and memory (not illustrated). Without limited thereto, the network entity 900 may include more or less components than those shown in FIG. 9.

According to an embodiment of the disclosure, the transceiver 920 may transmit/receive signals to/from the consumer NF 800, the UPF 700 or the UE (not illustrated). The signals transmitted/received with the network entity may include control information and data. The transceiver 920 may receive signals via a radio channel, output the signals to the processor 910, and transmit signals output from the processor 910 via a radio channel.

According to an embodiment of the disclosure, the processor 910 may control the network entity to perform any one of the above-described embodiments. The processor 910, the memory (not illustrated), and the transceiver 920 are not necessarily implemented in separate modules but rather as a single component, e.g., a single chip. The processor 910 and the transceiver 920 may be electrically connected with each other. The processor 910 may be an application processor (AP), a communication processor (CP), a circuit, an application-specific circuit, or at least one processor.

According to an embodiment of the disclosure, the memory (not illustrated) may store a default program for operating the UE, application programs, and data, such as configuration information. The memory provides the stored data according to a request of the processor 910. The memory may include a storage medium, such as ROM, RAM, hard disk, CD-ROM, and DVD, or a combination of storage media. There may be provided a plurality of memories. The processor 910 may perform the above-described embodiments based on a program for performing the above-described embodiments stored in the memory.

It should be noted that the above-described configuration views, example views of control/data signal transmission methods, example views of operational procedures, and configuration views are not intended as limiting the scope of the disclosure. In other words, all the components, entities, or operational steps described in connection with the embodiments should not be construed as essential components to practice the present invention, and the present invention may be rather implemented with only some of the components without departing from the gist of the present invention. The embodiments may be practiced in combination, as necessary. For example, some of the methods proposed herein may be combined to operate the network entity and the UE.

The above-described operations of the base station or UE may be realized by equipping a memory device retaining their corresponding codes in the base station device or any component of the UE. That is, the controller in the eNB or terminal may execute the above-described operations by reading and executing the program codes stored in the memory device by a processor or central processing unit (CPU).

As described herein, various components or modules in the entity, base station or UE may be operated using a hardware circuit, e.g., a complementary metal oxide semiconductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or ASICs.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof. In other words, it is apparent to one of ordinary skill in the art that various changes may be made thereto without departing from the scope of the present invention. Further, the embodiments may be practiced in combination. For example, some of the methods proposed herein may be combined to operate the base station and the UE. Although the embodiments are proposed in association with 5G and NR systems, various modifications thereto may apply to other various systems, such as LTE, LTE-A, LTE-A-Pro systems.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method performed by a user plane function (UPF) entity in a wireless communication system, the method comprising:
receiving, from an external network function (NF) entity, a registration request message including first authentication information; and
transmitting, to the external NF entity, a registration response message including second authentication information,
wherein the first authentication information, the second authentication information, and third authentication information obtained by the external NF entity are used for mutual authentication between a network including the UPF entity and the external NF entity.

2. The method of claim 1, comprising:
transmitting, to an authentication server function (AUSF) entity through a session management function (SMF) entity, the first authentication information; and
receiving, from the AUSF entity through the SMF entity, a message including an encryption key and an integrity key based on the first authentication information.

3. The method of claim 2, further comprising:
storing the encryption key and the integrity key;
encrypting a first UPF control message protocol (UCMP) message based on the encryption key; and
transmitting, to the external NF entity, the encrypted first UCMP message,

4. The method of claim 3, further comprising:
receiving, from the external NF entity, an encrypted second UCMP message; and
decrypting the second UCMP message based on the encryption key.

5. A method performed by an external network function (NF) entity in a wireless communication system, the method comprising:
obtaining first authentication information and second authentication information based on a preconfigured key for the external NF entity;
transmitting, to a user plane function (UPF) entity, a registration request message including the first authentication information;
receiving, from the UPF, a registration response message including third authentication information; and
determining whether the second authentication information and the third authentication information are the same,
wherein the first authentication information, the second authentication information, and the third authentication information are used for mutual authentication between a network including the UPF entity and the external NF entity.

6. The method of claim 5, further comprising:
obtaining an authentication key based on a key for the external NF entity;
obtaining a first encryption key and an integrity key based on the authentication key;
receiving, from the UPF entity, a first UPF control message protocol (UCMP) message, wherein the first UCMP message is encrypted by a second encryption key obtained from an authentication server function (AUSF) entity; and
decrypting the received UCMP message based on the first encryption key.

7. The method of claim 6, further comprising:
encrypting a second UCMP message based on the first encryption key; and
transmitting, to the UPF entity, the encrypted second UCMP message.

8. A user plane function (UPF) entity in a wireless communication system, comprising:
a transceiver; and
at least one processor, wherein the at least one processor is configured to:
receive, from an external network function (NF) entity, a registration request message including first authentication information, and
transmit, to the external NF entity, a registration response message including second authentication information,
wherein the first authentication information, the second authentication information, and third authentication information obtained by the external NF entity are used for mutual authentication between a network including the UPF entity and the external NF entity.

9. The UPF entity of claim 8, wherein the at least one processor is configured to:
transmit, to an authentication server function (AUSF) entity through a session management function (SMF) entity, the first authentication information; and
receive, from the AUSF entity through the SMF entity, a message including an encryption key and an integrity key based on the first authentication information.

10. The UPF entity of claim 9, wherein the at least one processor is configured to:
store the encryption key and the integrity key;
encrypt a first UPF control message protocol (UCMP) message based on the encryption key; and
transmit, to the external NF entity, the encrypted first UCMP message.

11. The UPF entity of claim 10, wherein the at least one processor is configured to:
receive, from the external NF entity, an encrypted second UCMP message; and
decrypt the second UCMP message based on the encryption key.

12. An external network function (NF) entity in a wireless communication system, comprising:
a transceiver; and
at least one processor, wherein the at least one processor is configured to:
obtain first authentication information and second authentication information based on a preconfigured key for the external NF entity;
transmit, to a user plane function (UPF) entity, a registration request message including the first authentication information;
receive, from the UPF, a registration response message including third authentication information; and
determine whether the second authentication information and the third authentication information are the same,
wherein the first authentication information, the second authentication information, and the third authentication information are used for mutual authentication between a network including the UPF entity and the external NF entity.

13. The external NF entity of claim 12, wherein the at least one processor is configured to:
obtain an authentication key based on a key for the external NF entity;
obtain a first encryption key and an integrity key based on the authentication key;
receive, from the UPF entity, a first UPF control message protocol (UCMP) message, wherein the first UCMP message is encrypted by a second encryption key obtained from an authentication server function (AUSF) entity; and
decrypt the received UCMP message based on the first encryption key.

14. The external NF entity of claim 13, wherein the at least one processor is configured to:
encrypt a second UCMP message based on the first encryption key; and
transmit, to the UPF entity, the encrypted second UCMP message.
